(19) United States
(12) Patent Application Publication
(10) Pub. No.: US 2021/0359837 A1
(43) Pub. Date: Nov. 18, 2021

(54) SYSTEMS AND METHODS FOR SECURE DATA COMPUTING AND ALGORITHM SHARING

(71) Applicant: Honeywell International Inc., Morris Plains, NJ (US)

(72) Inventors: Wenfan GUO, Beijing (CN); Feng JING, Beijing (CN)

(73) Assignee: Honeywell International Inc.

(21) Appl. No.: 16/872,716

(22) Filed: May 12, 2020

(51) Int. Cl. H04L 9/06; H04L 9/08

(52) U.S. Cl. CPC H04L 9/0618; H04L 9/0869; H04L 2209/08; H04L 2209/46; H04L 2209/38

(57) ABSTRACT

Disclosed are systems, methods, and non-transitory computer-readable medium for securely sharing data computations and algorithms. The method may include: receiving, by one or more processors, at least one algorithm function; generating, by the one or more processors, a protection function using the received algorithm function; generating, by the one or more processors, a Boolean circuit function based on the protection function; receiving, by the one or more processors, at least one encrypted data inputs; evaluating, by the one or more processors, the encrypted data inputs using the generated Boolean circuit function to generate evaluated results; and transmitting, by the one or more processors, the evaluated results.

### TECHNICAL FIELD

Various embodiments of the present disclosure generally relate to a secure platform for algorithm and data computations and results trading, and more particularly, to a distributed computation and knowledge sharing platform with guaranteed privacy and trust flow.

### BACKGROUND

Airlines are constantly trying to be successful by managing various costs. For example, fuel cost is about 25% of the total airline cost and maintenance cost is about 8% to 10% of the total airline cost. One of the major problems faced by airlines is how to improve operation efficiency and reduce operating costs. Airlines own very large amounts of data, however they lack the knowledge and system design to properly analyze the data. At the same time, due to data privacy and security, the airlines may not be able to share or make the data available to other parties without a way to control the security of the data. Airlines may be afraid of data leak, especially on sensitive data such as flight plan, and these concerns have heavily impacted the progress of airline related projects.

Further, algorithm suppliers, such as airline equipment suppliers, may provide algorithms to the airlines to analyze the data. However, the suppliers may likewise have privacy and security concerns with sharing the algorithms. Current data security systems may lack the ability to maintain privacy across the data providers and algorithm suppliers.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF DISCLOSURE

According to certain aspects of the disclosure, systems and methods are disclosed to provide secure platform for algorithm and data computations and results trading.

In one embodiment, a computer-implemented method is disclosed for securely sharing data computations and algorithms. The method may include: receiving, by one or more processors, at least one algorithm function; generating, by the one or more processors, a protection function using the received algorithm function; generating, by the one or more processors, a Boolean circuit function based on the protection function; receiving, by the one or more processors, at least one encrypted data inputs; evaluating, by the one or more processors, the encrypted data inputs using the generated Boolean circuit function to generate evaluated results; and transmitting, by the one or more processors, the evaluated results.

According to another aspect of the disclosure, a computer system for securely sharing data computations and algorithms may include at least one memory having processor-readable instructions stored therein; and at least one processor configured to access the memory and execute the processor-readable instructions, which when executed by the processor configures the processor to perform a plurality of functions. The functions may comprise receive at least one algorithm function; generate a protection function using the received algorithm function; generate a Boolean circuit function based on the protection function; receive at least one encrypted data inputs; evaluate the encrypted data inputs using the generated Boolean circuit function to generate evaluated results; and transmit the evaluated results.

According to still another aspect of the disclosure, a non-transitory computer-readable medium comprising instructions for securely sharing data computations and algorithms, the non-transitory computer-readable medium storing instructions that, when executed by at least one processor, may configure the at least one processor to perform receiving, by one or more processors, at least one algorithm function; generating, by the one or more processors, a protection function using the received algorithm function; generating, by the one or more processors, a Boolean circuit function based on the protection function; receiving, by the one or more processors, at least one encrypted data inputs; evaluating, by the one or more processors, the encrypted data inputs using the generated Boolean circuit function to generate evaluated results; and transmitting, by the one or more processors, the evaluated results.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment in which systems, methods, and other aspects of the present disclosure may be implemented.

FIG. 2 depicts an exemplary network, according to one or more embodiments.

FIG. 3 depicts an exemplary platform architecture, according to one or more embodiments.

FIG. 4 depicts an exemplary flow chart for providing secure algorithm and data computation, according to one or more embodiments.

FIG. 5 depicts an exemplary process for secure algorithm and data computation, according to one or more embodiments.

FIG. 6 depicts an exemplary computer device or system, in which embodiments of the present disclosure, or portions thereof, may be implemented

### DETAILED DESCRIPTION OF EMBODIMENTS

As discussed above, it is important for airlines to utilize data analytics algorithms to improve operational and maintenance efficiency and reduce operating and maintenance costs. The airlines may own large amounts of data related to the operations and maintenance of the aircrafts as well as various historical data stored on aircraft equipment. However, the airlines may lack the knowledge and/or the skills of data analytics and system design. On the other hand, aircraft equipment suppliers may have a better understanding of aircraft system design and inherent data analysis algorithms. The aircraft equipment suppliers may use algorithm and data together to provide predictive maintenance advices for equipment such as the auxiliary power unit (APU) and/or the environment control system (ECS) and operational services such as optimizing trajectory or fuel efficiency. However, because the aircraft equipment suppliers do not own the data directly, they may not have access to the data as needed. For example, access to sensitive data related to flight plan and flight quality from the quick access recorder (QAR) may not be possible for the aircraft equipment suppliers.

Therefore, a need exists for a platform for distributed data computation, storage and sharing with guaranteed privacy and trust flow. The platform may be used to protect the security of private data from data owners (e.g., airlines) and algorithms from algorithm owners (e.g., aircraft equipment suppliers) as well as providing an improved consolidation of both algorithm and data together for analysis. The platform may be based on blockchain and secure multi-party computing (MPC) technology.

The platform may be comprised of peer-to-peer networks enabling data providers and algorithm providers to jointly execute computations with core algorithms and data while keeping the sensitive data and algorithms completely private. A blockchain may be utilized as the controller of the network nodes. The functions of the controller of the network nodes may include managing access control and identities, handling algorithm call requests, receiving knowledge transaction request, and serve as a temper-proof log of events. Each of the network nodes may include an MPC node and a blockchain node. The algorithm calling requests may be facilitated via the blockchain nodes, which may enforce access-control based on digital signatures and programmable permissions. The computation of the algorithms may be based on a highly optimized version of the secure MPC and guaranteed by a verifiable secret-sharing scheme. The platform may also provide secure storage by storing the private data and core algorithms off-chain on the MPC node under local security monitoring. A modified distributed hash table may be used on-chain for holding the index for secret-shared data.

The subject matter of the present description will now be described more fully hereinafter with reference to the accompanying drawings, which form a part thereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter can be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

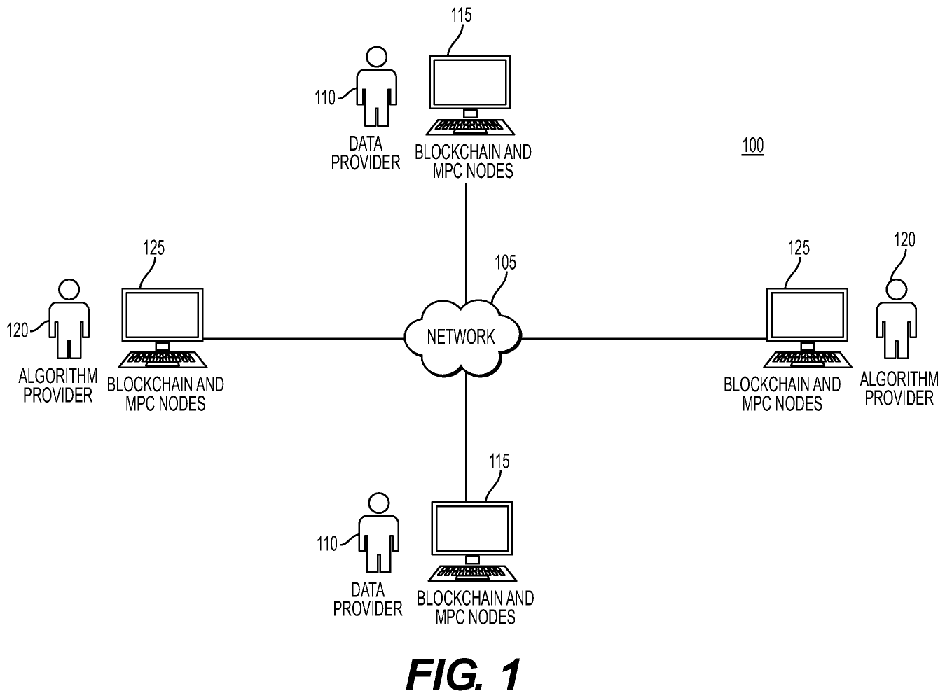

Referring now to the appended drawings, FIG. 1 depicts an exemplary environment 100 in which systems, methods, and other aspects of the present disclosure may be implemented. Environment 100 may include one or more data providers 110 and one or more blockchain and MPC nodes 115 under the operation of the one or more data providers 110. The one or more data providers 110 may be airlines, or other parties that may own and provide sensitive data. The environment 100 may also include one or more algorithm providers 120 and one or more blockchain and MPC nodes 125 under the operation of the one or more algorithm providers 120. The one or more algorithm providers 120 may be aircraft equipment providers, or other parties that may own algorithms for data analysis. The one or more data providers 110 and blockchain and MPC nodes 115 may be connected to the one or more algorithm providers 120 and blockchain and MPC nodes 125 via network 105. Various systems and devices of environment 100 may communicate via network 105 in any arrangement. While the exemplary embodiment includes reference to airlines, aircraft, aircraft equipment providers, it is understood that the one or more data providers 110 and the one or more algorithm providers 120 may include any type of data provider or algorithm provider, respectively.

In various embodiments, network 105 may be a wide area network (“WAN”), a local area network (“LAN”), personal area network (“PAN”), or the like. In some embodiments, network 105 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”).

As indicated above, FIG. 1 is provided merely as an example. Other examples are possible and may differ from what was described with regard to FIG. 1. The number and arrangement of devices and networks shown in FIG. 1 are provided as an example. In practice, there may be additional devices, fewer devices and/or networks, different devices and/or networks, or differently arranged devices and/or networks than those shown in FIG. 1. Furthermore, in various embodiments features of certain systems, such as the blockchain and MPC nodes 115 and 125, may be incorporated partially or completely into any of the other systems of FIG. 1. For example, in some embodiments, the blockchain and MPC nodes 115 and 125 may be incorporated into data provider 110 and algorithm provider 120 respectively. Additionally, or alternatively, a set of devices (e.g., one or more devices) of environment 100 may perform one or more functions described as being performed by another set of devices of environment 100.

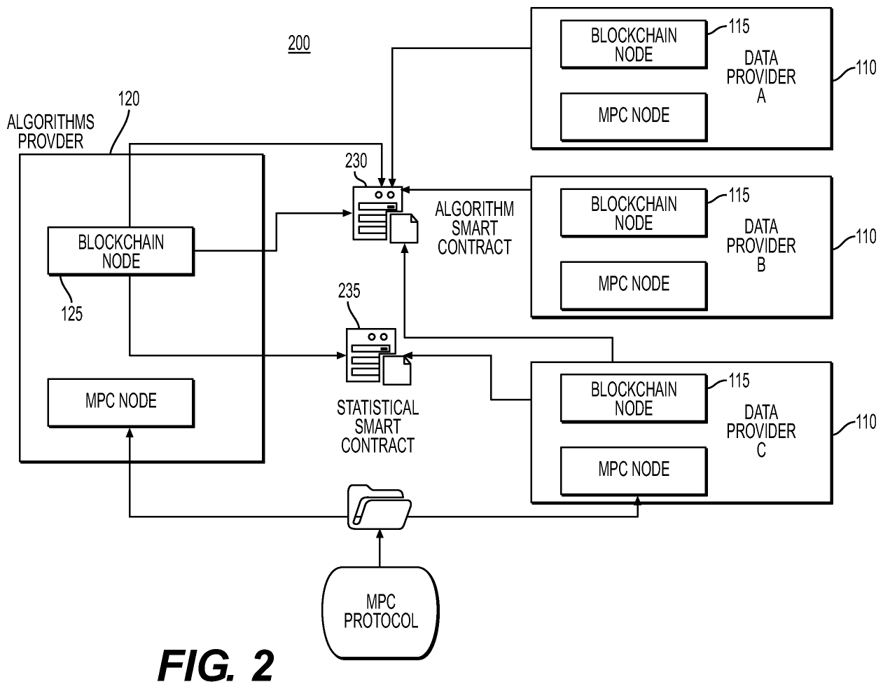

FIG. 2 depicts an exemplary network 200, according to one or more embodiments. The network 200 may execute functions for collaborative computing (e.g., secure data processing) and knowledge sharing. The computation model may be a highly optimized version of secure multi-party computation, guaranteed by a verifiable secret-sharing scheme. Network 200 may include one or more data providers 110 (e.g., data provider A, data provider B, data provider C, etc.), at least one algorithm provider 120, algorithm smart contract 230, and statistical smart contract 235. Each data provider 110 and the at least one algorithm provider 120 may have a blockchain node and MPC node 115 and blockchain node and MPC node 115 respectively. The MPC nodes may include either private data or algorithm according to provider type stored in a trusted storage space. Private data and core algorithm may be stored off-chain on the MPC node under the local security monitoring. A modified distributed hash table may be used on-chain for holding index of secret-shared data (e.g., hash values of private data and core algorithm).

When executing functions for collaborative computing, each of the algorithm provider 120 and data provider 110 (e.g., airline C) may first deploy a local MPC node and a local blockchain node respectively. The local MPC node and the local blockchain node may physically reside on one computer, or may be separately deployed into different partitions logically. After deploying the local blockchain and MPC nodes, the algorithm provider 120 may broadcast algorithms externally via the blockchain node, and publishing the types and descriptions of the algorithms to the algorithm smart contract 230. The algorithm smart contract 230 may be a repository for the algorithms owned by the algorithms provider 120. Each algorithms provider 120 may have their own algorithm smart contract, or one algorithm smart contract may be shared by multiple algorithm providers. The algorithms provided by the provider 120 may be encrypted at the local node of the provider prior to transmitting to the algorithm smart contract. In another embodiment, the algorithms provided by the provider 120 may be encrypted by the algorithm smart contract.

The data provider 110 (e.g., airline C) may initiate the execution of the collaborative computing at the data provider's choosing. When the data provider 110 wants to perform the collaborative calculation, the locally deployed blockchain node 115 may initiate the request and broadcasts it on the blockchain. When the blockchain node locally deployed under the control of the data provider 110 (e.g., airline C) initiates an algorithm call request, a mechanism integrating execution of the secure-MPC protocol on the related MPC nodes may consolidate both algorithm and data together and execute algorithm over data without leaking the raw data to any of the nodes, while ensuring correct execution.

Upon receiving the request, the blockchain node 125 of the algorithm provider 120 may send a response message notifying the data provider 110 (e.g., airline C) of receipt of the request. The algorithm smart contract 230 may then call the execution of any specific algorithm on the data provided by the data provider 110 (e.g., airline C) using the secure-MPC protocol and automatically count the number of algorithm calls and verify that the accounts among the participants are consistent in the blockchain nodes. While executing the collaborative computing, both algorithm providers 120 and data providers 110 (e.g., airline C) may chain hash values of the algorithms and data respectively for any possible subsequent audits. The hash chain may be produced by applying a cryptographic hash function to the algorithms and/or the data. The hash values may be identified and visualized in the unique digital identify stored on the blockchain node of the respective algorithm provider 120 and data provider 110 (e.g., airline C). Upon the completion of the collaborative computing by the locally deployed MPC nodes of the algorithms provider 120 and the data provider 110 (e.g., airline C), the chain hash value of the computed results may then be stored on the blockchain. The stored chain hash value may then be used for knowledge sharing. As an example of the collaborative computing, algorithm provider 120 may own a temperature analysis algorithm and provides access to the algorithm. A ground of data providers 110 may provide access to their own temperature data. The parties may use the secure-MPC protocol to compute the average temperature of the group by combining the temperature analysis algorithm and data together and compute the results. Utilizing the secure-MPC protocol ensures that data providers do not know each other's temperature data inputs and cannot back compute the temperature data from the computed results.

The knowledge sharing function may be performed after the algorithm provider 120 and the data provider 110 (e.g., airline C) have stored the hash value of the computed results. For example, other data providers (e.g., airline A) may be interested in the results of the MPC calculations between the algorithm provider and data provider, and may initiate a knowledge transaction request through locally deployed blockchain nodes. After receiving the knowledge transaction request from the other data providers (e.g., airline A), the algorithms provider 120 and data provider 110 (e.g., airline C) may agree to apply for a proxy re-encryption contract (e.g., statistical smart contract 235) to authorize the other data providers (e.g., airline A) to view the computed results. The proxy re-encryption contract guarantees that authorized computing results may only be viewed by authorized parties. After authorization, the original text is re-encrypted into a cipher text of the designated authorizer, thereby ensuring that only the authorized licensors can use their private key to decrypt the encrypted data. The other data providers (e.g., airline A) may then receive the authorization to view the computed results and may access the computed results. The knowledge transaction record may then be stored on the locally deployed blockchain. The statistical smart contract 235 may also automatically count the number of access to the computed results and record the parties that have accessed the computed results.

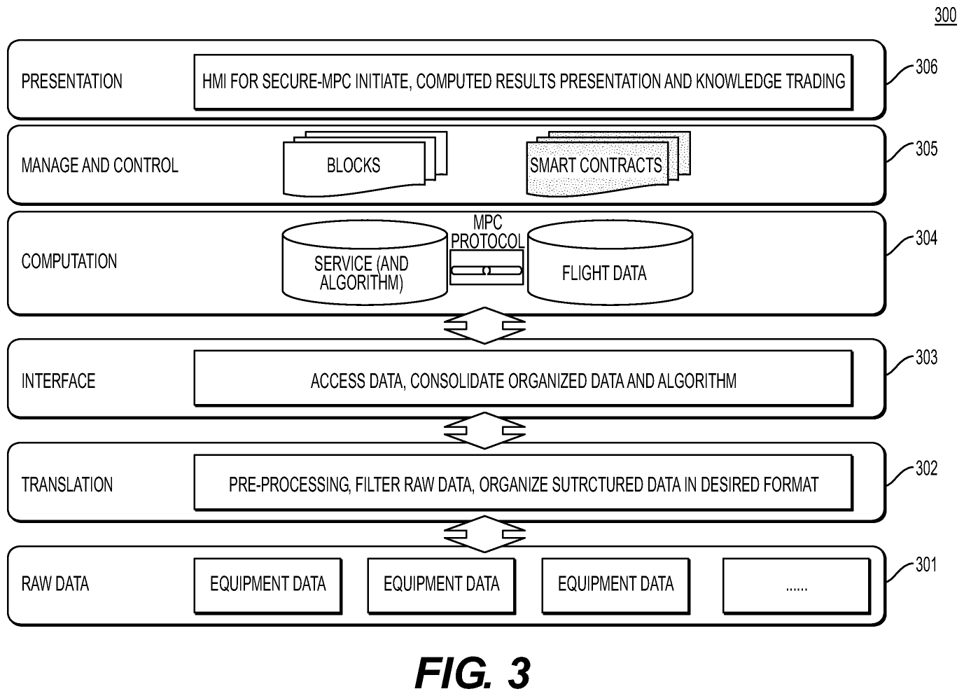

FIG. 3 depicts an exemplary platform architecture 300, according to one or more embodiments. The architecture 300 may include a raw data layer 301, a translation layer 302, an interface layer 303, a computation layer 304, a control layer 305, and a presentation layer 306. The raw data layer 301 may include original data sources from various aircraft equipment. For example, data may include QAR data collected from QAR equipment, APU data collected from APU equipment, traffic collision avoidance system (TCAS) data collected from the TCAS equipment, weather radar data collected from weather radar equipment, flight management system (FMS) data collected from FMS equipment, and wheel break data collected from the landing gear equipment. The translation layer 302 may function to filter and pre-process the data supplied by the raw data layer 301 and organize the data in a structured and desired data format. The interface layer 303 may be able to provide access to the data during the process of secure-MPC. The computation layer 304 may function to consolidate data and algorithm together and execute computations with core algorithm and data based on integrating execution of the secure-MPC protocol. The control layer 305 may be utilized as the controller of the network nodes, manage access control and identities, handle algorithm call requests, knowledge transaction requests, and provide a secure tamper-proof log of events. The presentation layer 306 may be a human-machine interface (HMI) configured for initiating secure-MPC and display a presentation of computed results and a variety of log events. It is understood that the layers 301-306 may be combined and/or separated into any number of layers as necessary.

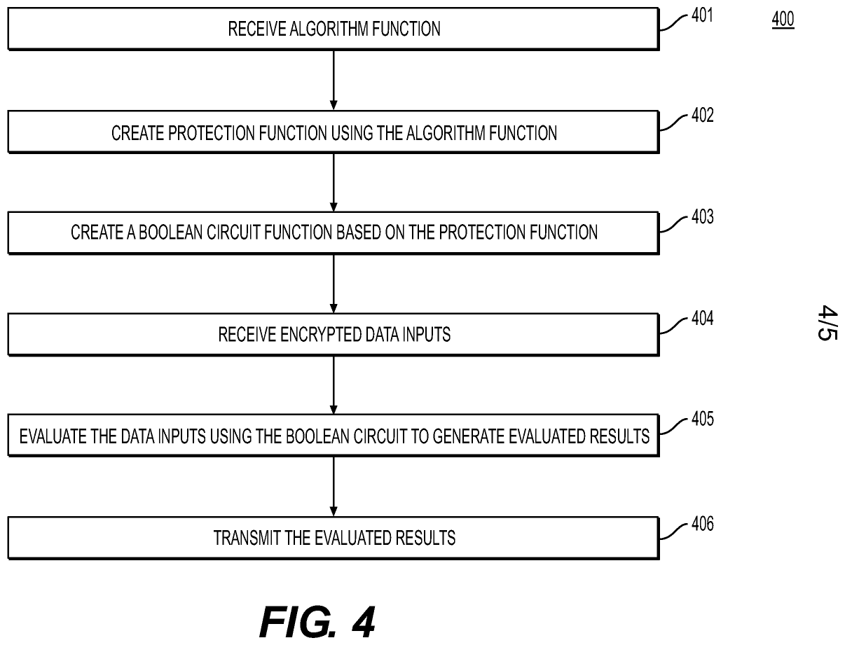

FIG. 4 depicts an exemplary flow chart of a method 400 for securely sharing data computation and algorithms, according to one or more embodiments. Method 400 may begin at step 401 with receiving, by one or more processors (e.g., CPU 620), algorithm functions provided by algorithm provider 120. At step 402, a protection function may be created, by the one or more processors, using the received algorithm function. The protection function may be created using any encryption algorithm and may use the original function and data provided by data providers 110 as input parameters of the protection function. The protection function may ensure that the data provided by the data providers 110 and the algorithm provided by the algorithm provider 120 are protected.

At step 403, the algorithm provider 120 may generate, by the one or more processors, a Boolean circuit version of the protection function. The Boolean circuit function may be software, or may be a combination of software and hardware. The algorithm provider 120 may further transform, by the one or more processors, the circuit into a garbled circuit by garbling the truth table for each gate in the circuit. Garbling the circuit may include encrypting, by the one or more processors, each entry of the truth table using randomly generated keys and randomizing the order of rows in the truth table. As an example of circuit garbling, each gate of the circuit may be represented as a truth table. For each input line, two random labels may be selected to represent “0” or “1”. The labels and the association to “0” and “1” may be kept confidential. After selection of the labels, all “0” and “1” values in the truth table may be replaced by the labels, and an encryption circuit may be generated using two encryption input labels.

At step 404 data inputs may be received, by the one or more processors, from the data provider 110. The data inputs may be encrypted by the provider 110 prior to sending the data. At step 405, the one or more processors may evaluate the data inputs using the Boolean circuit to generate evaluated results. For example, the Boolean circuit may be executed, by the one or more processors, using the received data inputs. At step 406, the evaluated results may be transmitted, by the one or more processors, to the data providers 110. As an example of evaluation of data using the garbled circuit, input labels may be first received by the circuit, however the circuit may not know the correspondence between the input labels and the “0” and “1” values. The circuit may then use the generated encryption keys to decrypt the truth table of each gate of the circuit and execute the algorithms using the input labels. Finally, the label of the output line may be decrypted. The correspondence between the label of the output line and the “0” and “1” values may be made public to allow the data providers to receive the computed result. As detailed above, the one or more processors may deploy a blockchain node and a MPC node 115, 125. The one or more processors may store the evaluated results on the blockchain node.

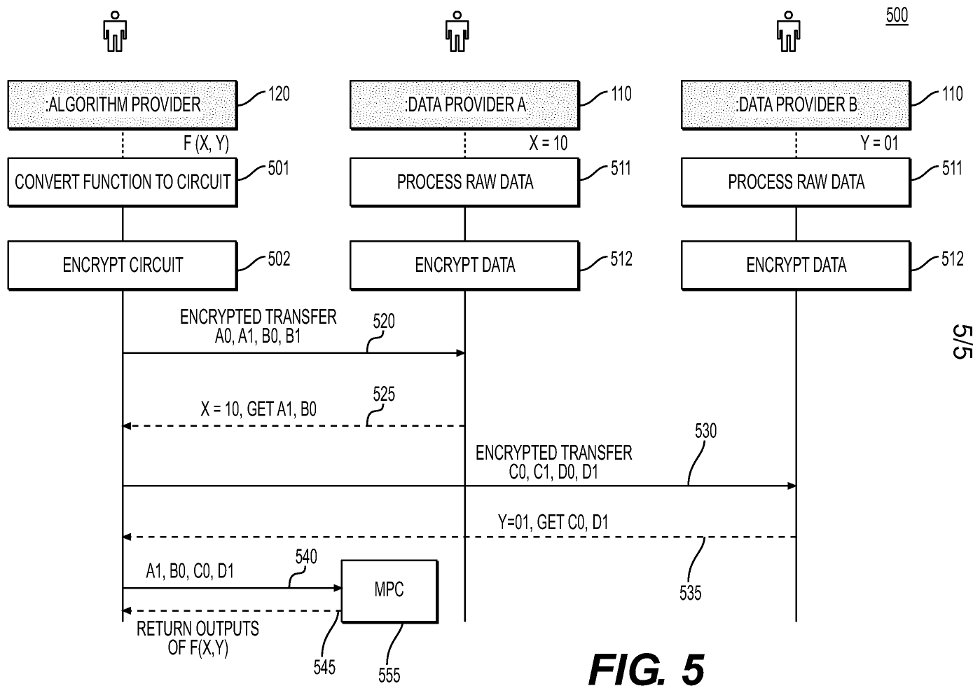

FIG. 5 depicts an exemplary process 500 for secure algorithm and data computation, according to one or more embodiments. Process 500 may include the algorithm provider 120 performing a conversation of the protection algorithm function (e.g., F(X,Y)) to a Boolean circuit at 501. At 502, the Boolean circuit may be encrypted as described above. The process 500 may also include one or more data provider 110 performing data processing of the raw input data at 511. At 512 the input data may be encrypted.

The algorithm provider 120 may then make the encrypted circuit available to data providers 110 to supply input data (e.g., A0, A1, B0, B1, or C0, C1, D0, D1) at 520 and 530. The encrypted circuit may be made available using any encrypted transfer method, such as oblivious transfer. At 525 and 535, encrypted data inputs are supplied from the data providers 110. At 555 a secure-MPC execution may be performed to consolidate the data and algorithms at 540 and compute the algorithm with the supplied data. Upon the completion of the computation, at 545 the output of the function (e.g., F(X,Y)) may be returned and stored on a locally deployed blockchain node for access.

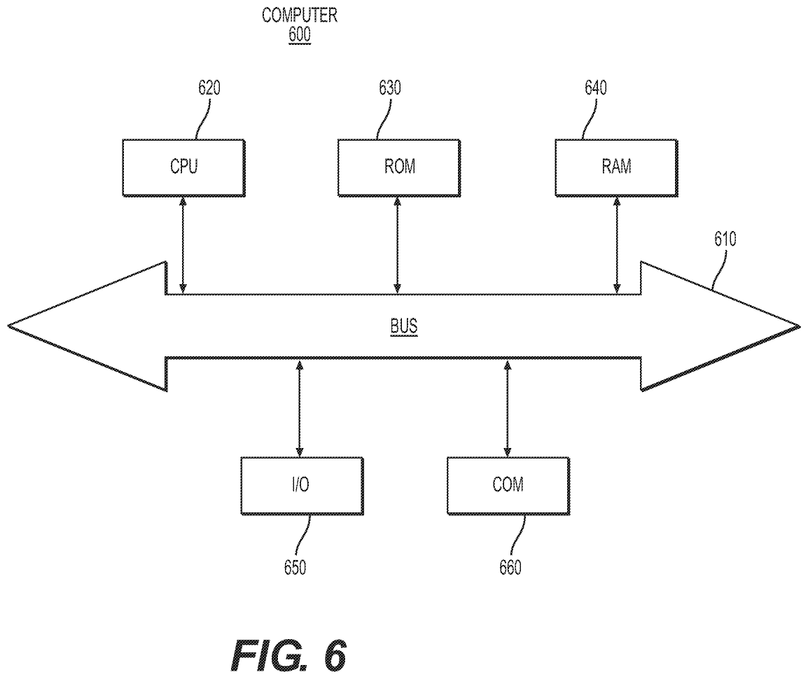

FIG. 6 depicts a high-level functional block diagram of an exemplary computer device or system, in which embodiments of the present disclosure, or portions thereof, may be implemented, e.g., as computer-readable code. Additionally, each of the exemplary computer servers, databases, user interfaces, modules, and methods described above with respect to FIGS. 1-5 can be implemented in device 600 using hardware, software, firmware, tangible computer readable media having instructions stored thereon, or a combination thereof and may be implemented in one or more computer systems or other processing systems. Hardware, software, or any combination of such may implement each of the exemplary systems, user interfaces, and methods described above with respect to FIGS. 1-5.

If programmable logic is used, such logic may be executed on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor or a plurality of processors, or combinations thereof. Processor devices may have one or more processor “cores.”

Various embodiments of the present disclosure, as described above in the examples of FIGS. 1-5, may be implemented using device 600. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As shown in FIG. 6, device 600 may include a central processing unit (CPU) 620. CPU 620 may be any type of processor device including, for example, any type of special purpose or a general-purpose microprocessor device. As will be appreciated by persons skilled in the relevant art, CPU 620 also may be a single processor in a multi-core/multiprocessor system, such system operating alone, or in a cluster of computing devices operating in a cluster or server farm. CPU 620 may be connected to a data communication infrastructure 610, for example, a bus, message queue, network, or multi-core message-passing scheme.

Device 600 also may include a main memory 640, for example, random access memory (RAM), and also may include a secondary memory 630. Secondary memory 630, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 630 may include other similar means for allowing computer programs or other instructions to be loaded into device 600. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 600.

Device 600 also may include a communications interface (“COM”) 660. Communications interface 660 allows software and data to be transferred between device 600 and external devices. Communications interface 660 may include a modem, a network interface (such as an Ethernet card), a communications port, a PCMCIA slot and card, or the like. Software and data transferred via communications interface 660 may be in the form of signals, which may be electronic, electromagnetic, optical, or other signals capable of being received by communications interface 660. These signals may be provided to communications interface 660 via a communications path of device 600, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 600 also may include input and output ports 650 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

It is intended that the specification and examples be considered as exemplary only, with a true scope and spirit of the disclosure being indicated by the following claims.

What is claimed is:

1. A computer-implemented method for securely sharing data computations and algorithms, the method comprising:
receiving, by one or more processors, at least one algorithm function;
generating, by the one or more processors, a protection function using the received algorithm function;
generating, by the one or more processors, a Boolean circuit function based on the protection function;
receiving, by the one or more processors, at least one encrypted data inputs;
evaluating, by the one or more processors, the encrypted data inputs using the generated Boolean circuit function to generate evaluated results; and
transmitting, by the one or more processors, the evaluated results.

2. The computer-implemented method of claim 1, further includes:
deploying, by the one or more processors, a blockchain node and a MPC node.

3. The computer-implemented method of claim 2, further includes:
storing, by the one or more processors, the evaluated results on the blockchain node.

4. The computer-implemented method of claim 3, further includes:
evaluating the encrypted data inputs using the generated Boolean circuit function on the MPC node.

5. The computer-implemented method of claim 1, further includes:
transforming, by the one or more processors, the Boolean circuit function into a garbled circuit.

6. The computer-implemented method of claim 5, wherein transforming the Boolean circuit function into a garbled circuit includes garbling a truth table for each gate in the Boolean circuit.

7. The computer-implemented method of claim 6, wherein garbling the truth table for each gate in the circuit includes encrypting each entry of the truth table using randomly generated encryption keys and randomizing the order of rows in the truth table.

8. A computer-implemented system for securely sharing data computations and algorithms, the computer-implemented system comprising:
a memory having processor-readable instructions stored therein; and
at least one processor configured to access the memory and execute the processor-readable instructions, which when executed by the processor configures the processor to perform a plurality of functions, including functions for:
receive at least one algorithm function;
generate a protection function using the received algorithm function;
generate a Boolean circuit function based on the protection function;
receive at least one encrypted data inputs;
evaluate the encrypted data inputs using the generated Boolean circuit function to generate evaluated results; and
transmit the evaluated results.

9. The computer-implemented system of claim 8, wherein the functions further include:
deploying a blockchain node and a MPC node.

10. The computer-implemented system of claim 9, wherein the functions further include:
storing the evaluated results on the blockchain node.

11. The computer-implemented system of claim 9, wherein the functions further include:
evaluating the encrypted data inputs using the generated Boolean circuit function on the MPC node.

12. The computer-implemented system of claim 8, wherein the functions further include:
transforming the Boolean circuit function into a garbled circuit.

13. The computer-implemented system of claim 12, wherein transforming the Boolean circuit function into a garbled circuit includes garbling a truth table for each gate in the circuit.

14. The computer-implemented system of claim 13, wherein garbling the truth table for each gate in the circuit includes encrypting each entry of the truth table using randomly generated encryption keys and randomizing the order of rows in the truth table.

15. A non-transitory computer-readable medium containing instructions for securely sharing data computations and algorithms, comprising:
receiving, by one or more processors, at least one algorithm function;
generating, by the one or more processors, a protection function using the received algorithm function;
generating, by the one or more processors, a Boolean circuit function based on the protection function;
receiving, by the one or more processors, at least one encrypted data inputs;
evaluating, by the one or more processors, the encrypted data inputs using the generated Boolean circuit function to generate evaluated results; and
transmitting, by the one or more processors, the evaluated results.

16. The non-transitory computer-readable medium of claim 15, further includes:
deploying, by the one or more processors, a blockchain node and a MPC node.

17. The non-transitory computer-readable medium of claim 16, further includes:
storing, by the one or more processors, the evaluate data inputs on the blockchain node.

18. The non-transitory computer-readable medium of claim 16, further includes:
evaluating the encrypted data inputs using the generated Boolean circuit function on the MPC node.

19. The non-transitory computer-readable medium of claim 15, further includes:
transforming, by the one or more processors, the Boolean circuit function into a garbled circuit.

20. The non-transitory computer-readable medium of claim 19, wherein garbling a truth table for each gate in the circuit include encrypting each entry of the truth table using randomly generated encryption keys and randomizing the order of rows in the truth table.
